(19) United States
(12) Patent Application Publication
(10) Pub. No.: US 2009/0207312 A1
(43) Pub. Date: Aug. 20, 2009

(54) VIDEO PROCESSING APPARATUS AND METHOD FOR PROCESSING VIDEO SIGNAL

(75) Inventor: Kohei Miyoshi, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/348,772

(22) Filed: Jan. 5, 2009

(30) Foreign Application Priority Data
Feb. 20, 2008 (JP) 2008-038570

(51) Int. Cl. H04N 5/57

(52) U.S. Cl. 348/687; 348/E05.119

(57) ABSTRACT

A video processing apparatus includes: a video processor configured to generate a video signal; an automatic image quality adjustment unit configured to determine a first image quality adjustment set value based on the video signal; a user image quality adjustment unit configured to determine a second image quality adjustment set value based on a user's operation; an image quality processor configured to perform an image quality adjustment on the video signal based on the first and second image quality adjustment set values; and a controller configured to: control the image quality processor to perform the image quality adjustment based on the first and the second image quality adjustment set values.

### CROSS-REFERENCE TO RELATED APPLICATIONS

This application is based upon and claims the benefit of priority from Japanese Patent Application No. 2008-038570, filed on Feb. 20, 2008, the entire content of which are incorporated herein by reference.

### BACKGROUND

1. Field

One embodiment of the present invention relates to a video processing apparatus and method for processing a video signal.

2. Description of the Related Art

As a conventional technique, a display apparatus is known in which an image to be viewed and an image to be adjusted are simultaneously displayed on a display device, and the image quality is adjusted based on an operation by the user. An example of such apparatus is disclosed in JP-A-2007-325091.

The display apparatus has: a display device on which a video image is displayed; a main-screen video processor which performs a video process of a video to be viewed, and a image quality adjustment; an adjustment-screen image processor which performs a video process of an adjustment image, and a image quality adjustment; a two-screen insertion circuit which inserts video images output from the main-screen video processor and the adjustment-screen image processor into one screen, and which displays the screen on the display device; and a controller which controls various components based on an operation signal from an operation interface. In the case where an operation for requesting a start of adjustment of the image quality is input through the operation interface, the video to be viewed and the adjustment image are displayed on the display device. When an operation for the image quality adjustment is input through the operation interface, the image quality adjustment is reflected in the adjustment image. When the operation for the image quality adjustment is completed, the image quality adjustment is reflected also in the video to be viewed. According to the configuration, an image quality adjustment can be easily performed without directly reflecting an image quality adjustment which makes the video to be viewed to be hardly viewable. The adjustment image can be selected from an adjustment image pattern, a still image, and the video to be viewed. In the case where the video to be viewed is selected, an image quality adjustment is reflected only in the adjustment image, whereby a change between the image in which the adjustment is not reflected, and that in which the adjustment is reflected can be checked.

In the conventional display apparatus, in the case where the apparatus has a function of automatically adjusting the image quality irrespective of an operation of the user and based on a video source, the external environment, or the like, however, the video to be viewed and the adjustment image are automatically adjusted during the image quality adjustment, thereby causing a problem in that an reflection of an operation performed by the user is hardly known.

### SUMMARY

According to one aspect of the present invention, there is provided a video processing apparatus including: a user interface configured to allow a user to input operations; a video processor configured to generate a video signal; an automatic image quality adjustment unit configured to determine a first image quality adjustment set value based on the video signal; a user image quality adjustment unit configured to determine a second image quality adjustment set value based on an operation input through the user interface; an image quality processor that performs an image quality adjustment on the video signal based on the first and second image quality adjustment set values; and a controller configured to: store the first image quality adjustment set value that is set before the user image quality adjustment unit starts to operate and control the image quality processor to perform the image quality adjustment based on the second image quality adjustment set value when the user image quality adjustment unit determines the second image quality adjustment set value; and control, after the image quality processor completes the image quality adjustment based on the second image quality adjustment set value, the image quality processor to perform the image quality adjustment based on the first image quality adjustment set value that is stored and the second image quality adjustment set value that is determined by the user image quality adjustment unit.

According to another aspect of the present invention, there is provided a video processing apparatus including: a sensor configured to detect an external environment and outputs a detection value that indicates the detected external environment; a user interface configured to allow a user to input operations; a video processor configured to generate a video signal; an automatic image quality adjustment unit configured to determine a first image quality adjustment set value based on the video signal and the detection value; a user image quality adjustment unit configured to determine a second image quality adjustment set value based on an operation input through the user interface; an image quality processor configured to perform an image quality adjustment on the video signal based on the first and second image quality adjustment set values; and a controller configured to: store the first image quality adjustment set value that is set before the user image quality adjustment unit starts to operate and control the image quality processor to perform the image quality adjustment based on the second image quality adjustment set value when the user image quality adjustment unit determines the second image quality adjustment set value; and control, after the image quality processor completes the image quality adjustment based on the second image quality adjustment set value, the image quality processor to perform the image quality adjustment based on the first image quality adjustment set value that is stored and the second image quality adjustment set value that is determined by the user image quality adjustment unit.

According to still another aspect of the present invention, there is provided a method for processing a video signal, the method including: detecting an external environment to obtain a detection value that indicates the detected external environment; performing an automatic image quality adjustment to determine a first image quality adjustment set value based on a video signal and the detection value; determining a second image quality adjustment set value based on an operation input by a user; storing the first image quality adjustment set value and performing the image quality adjustment based on the second image quality adjustment set value when the second image quality adjustment set value is determined; and performing an image quality adjustment on the video signal based on the first image quality adjustment set value and the second image quality adjustment set value.

### BRIEF DESCRIPTION OF THE SEVERAL VIEWS OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a schematic view showing a display apparatus of a first embodiment of the invention.

FIG. 2 is a block diagram showing a configuration example of the display apparatus of the first embodiment of the invention.

FIG. 3 is a diagram showing display contents of the display apparatus of the first embodiment of the invention.

FIG. 4 is a flowchart showing an example of the operation of the display apparatus of the first embodiment of the invention.

FIG. 5 is a flowchart showing an example of the operation of the display apparatus of the first embodiment of the invention.

FIG. 6 is a flowchart showing an example of the operation of a display apparatus of a second embodiment of the invention.

### DETAILED DESCRIPTION

Hereinafter, embodiments of a display apparatus according to the invention will be described in detail with reference to the accompanying drawings.

### First Embodiment

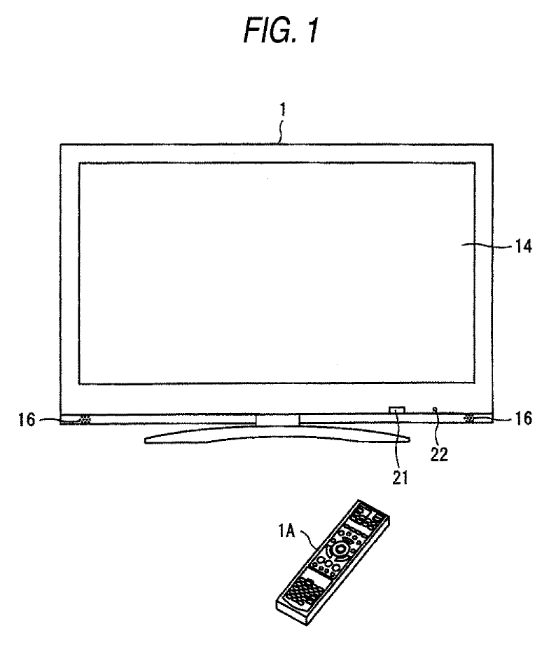

FIG. 1 is a schematic view showing a display apparatus of a first embodiment of the invention.

The display apparatus 1 is configured as a television receiver which receives a digital broadcast wave or the like from the outside via an antenna (not shown) to display a video image, and which receives a video signal from a video reproduction apparatus such as an HDD recorder or a DVD player (not shown) to display a video image. The display apparatus 1 is provided with: a video display device 14 configured by an LCD or the like in which a video image is displayed on the front face; a speaker 16 which outputs a sound; a light receiver 21 which receives an operation signal using an IR ray and transmitted from a remote controller 1A having plural operation switches; and an optical sensor 22 which is configured by a photodiode or the like that detects the illuminance of the external environment. The display apparatus 1 has an operation interface configured by an antenna terminal, external input terminals, and plural switches which are not shown, on the back face, and also has electronic components including a CPU (Central Processing Unit), a RAM (Random Access Memory), a ROM (Read Only Memory), and an HDD (Hard Disc Drive).

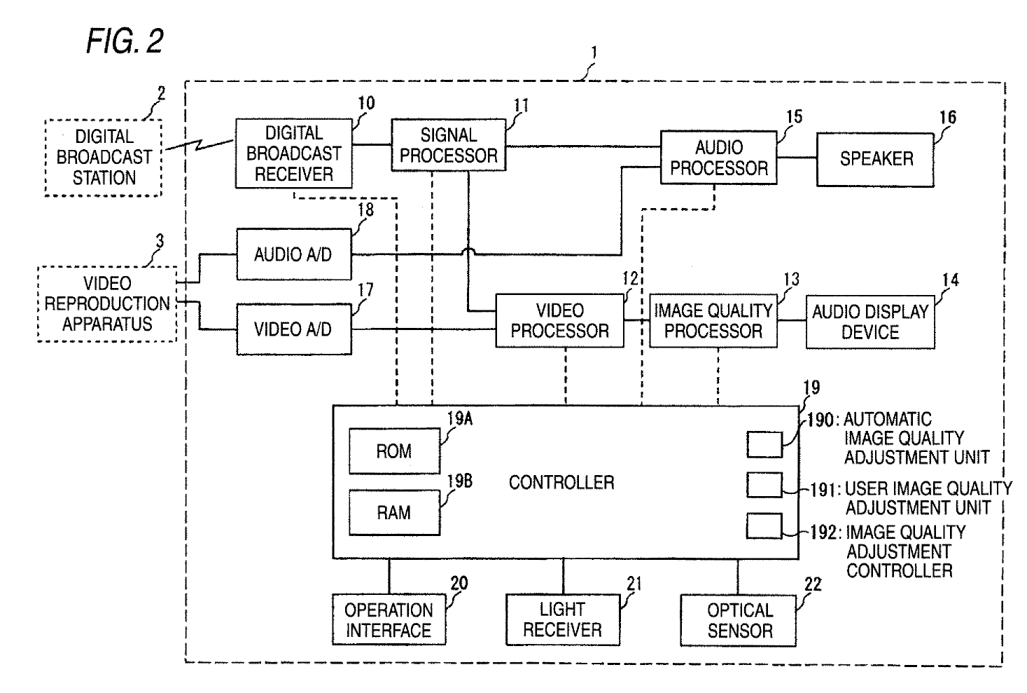

FIG. 2 is a block diagram showing a configuration example of the display apparatus of the first embodiment of the invention.

The display apparatus 1 includes a digital broadcast receiver 10 which receives a broadcast signal transmitted from a digital broadcast station 2. The output of the portion is connected to a signal processor 11. The signal processor 11 separates the received broadcast signal to an audio signal and a video signal, and the outputs are connected to an audio processor 15 and a video processor 12, respectively.

The output of the audio processor 15 is connected to the speaker 16, and that of the video processor 12 is connected to the video display device 14 configured by a CRT, a liquid crystal display apparatus, or the like, through an image quality processing device 13 which adjusts the image quality.

The display apparatus 1 further has a video A/D 17 and audio A/D 18 which respectively receive the video and audio signals transmitted from the video reproduction apparatus 3 that is connected to the external input terminals (not shown). The video and audio signals supplied to the video A/D 17 and the audio A/D 18 are converted from an analog signal to a digital signal, and the outputs of the A/Ds are connected to the video processor 12 and the audio processor 15, respectively.

The display apparatus 1 further has a controller 19 which controls various portions via control lines that are indicated by broken lines in FIG. 2. The operation interface 20 which is configured by the operation switches and the like, the light receiver 21 which receives the IR operation signal emitted from the remote controller 1A, and the optical sensor 22 which detects the illuminance of the external environment are connected to the controller 19.

The controller 19 has: a ROM 19A which stores programs and the like for controlling various portions; a RAM 19B which temporarily stores information to assist the operation of the controller 19; and an automatic image quality adjustment unit 190, user image quality adjustment unit 191, and image quality adjustment controller 192 which are stored in the ROM 19A, and which operate on the controller 19.

The automatic image quality adjustment unit 190 determines an image quality adjustment set value based on the video signal supplied to the video processor 12, and also based on the external environment illuminance which is measured by the optical sensor 22, and controls the image quality processor 13 based on the determined image quality adjustment set value. The automatic image quality adjustment unit 190 operates at time intervals in units of fields of video information, and adjusts the image quality of video information which is dynamically input.

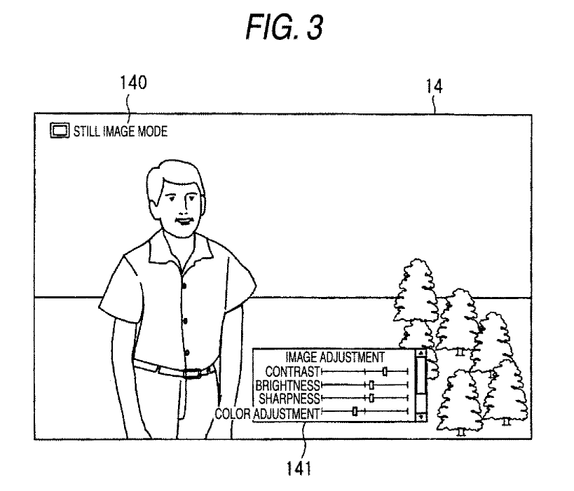

The user image quality adjustment unit 191 determines another image quality adjustment set value based on the operation signal which is received by the operation interface 20 or the light receiver 21, and controls the image quality processor 13 based on the determined image quality adjustment set value. When the user performs an image quality adjusting operation, for example, the user image quality adjustment unit 191 displays an image quality adjustment menu (FIG. 3) which will be described later, and, after the image quality adjusting operation, always applies the image quality adjustment set value which is determined on the image quality adjustment menu.

The image quality adjustment controller 192 controls the operations of the automatic image quality adjustment unit 190 and the user image quality adjustment unit 191. The control operation of the image quality adjustment controller 192 will be described in detail later.

FIG. 3 is a diagram showing the display contents of the display apparatus of the first embodiment of the invention.

When an operation for “STILL IMAGE MODE” is input through the operation interface 20 or the remote controller 1A, is the display apparatus 1 displays a still image mode indication 140 on the video display device 14, and at the same time activates the user image quality adjustment unit 191 to display a user image quality adjustment menu 141. The still image mode indication 140 and the user image quality adjustment menu 141 may not be simultaneously displayed. First, the still image mode indication 140 may be displayed, and the user image quality adjustment menu 141 may be then displayed.

The still image mode indication 140 is a display mode in which a certain frame of a viewed video image is obtained, and the frame is displayed as a still image on the video display device 14 to assist the image quality adjustment. In the user image quality adjustment menu 141, for example, parameters such as the contrast, the brightness, the sharpness, the color adjustment, the white balance, the luminosity, and the focus can be arbitrarily set based on an operation of the user.

Hereinafter, an example of an operation of the electronic apparatus of the first embodiment will be described with reference to the drawings.

The digital broadcast wave transmitted from the digital broadcast station 2 is input into the digital broadcast receiver 10 via the antenna which is not shown.

In the digital broadcast receiver 10, the received signal is demodulated by a demodulator (not shown) corresponding to the modulating method of the terrestrial digital broadcast, and a data string (transport stream) based on the MPEG2 standard or the like is extracted and then supplied to the signal processor 11.

The data stream (transport stream) supplied to the signal processor 11 is separated by an, for example, MPEG2 decoder (not shown) to an audio signal (digital) and a video signal (digital). The audio signal is supplied to the audio processor 15, and the video signal to the video processor 12.

In the audio processor 15, a process of converting the supplied audio signal (digital) to an analog audio signal, and the like is performed, and the analog audio signal is supplied to the speaker 16.

In the video processor 12, the interframe difference of the supplied video signal (digital) is detected, it is determined whether the video source is a movie film source that has undergone the 2-3 pull-down process or a usual video source other than a movie film source, and, after the image quality is adjusted in the image quality processor 13, the signal is converted as required to an analog signal or the like, and then supplied to the video display device 14 configured by a CRT, an LCD, or the like.

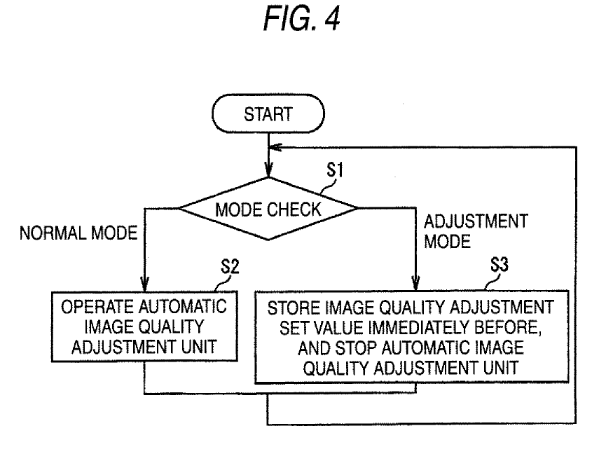

FIG. 4 is a flowchart showing an example of the operation of the display apparatus of the first embodiment of the invention.

The image quality adjustment controller 192 monitors the operation of the user image quality adjustment unit 191, and checks the operation mode of the portion (S1). In the case of “Normal mode” where the user image quality adjustment unit 191 does not operate (S1: Normal mode), the operation of the automatic image quality adjustment unit 190 is continued (S2).

In the case of “Adjustment mode” where the user image quality adjustment unit 191 is activated (S1: Adjustment mode), the image quality adjustment set value of the automatic image quality adjustment unit 190 which is obtained immediately before the activation of the user image quality adjustment unit 191 is stored, and the operation of the automatic image quality adjustment unit 190 is stopped (S3).

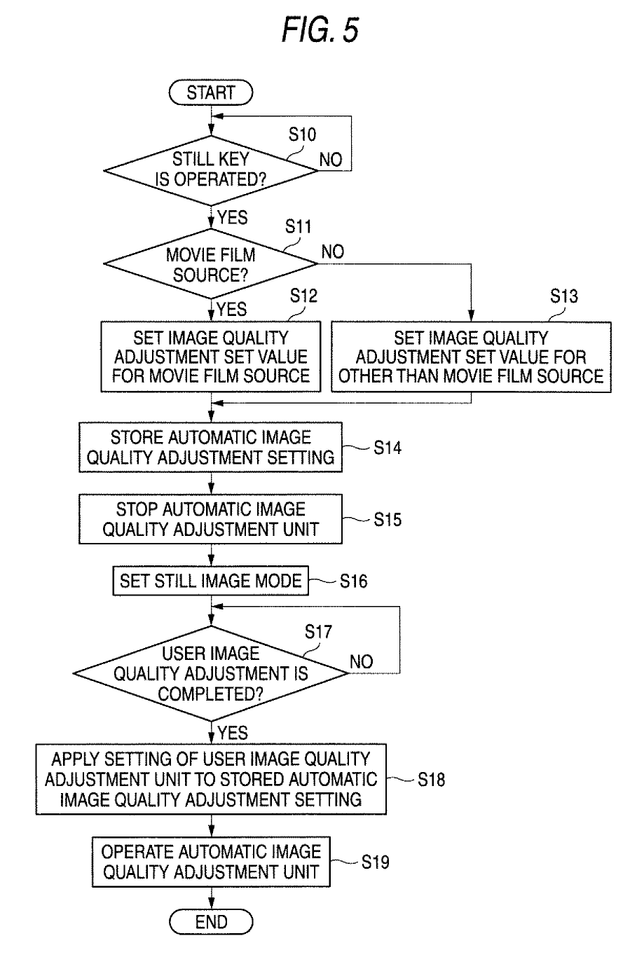

FIG. 5 is a flowchart showing an example of the operation of the display apparatus of the first embodiment of the invention.

First, if the image quality adjustment controller 192 recognizes that “STILL KEY” for transferring to the still image mode is operated in the operation interface 20 or the remote controller 1A, and the operation signal is input (S10: Yes), the user image quality adjustment unit 191 is activated, and the automatic image quality adjustment unit 190 is caused to operate.

The automatic image quality adjustment unit 190 inquires whether the video information supplied to the video processor 12 is a movie film source or not (S11). If the video information supplied to the video processor 12 is a movie film source (S11: Yes), the automatic image quality adjustment unit supplies an image quality adjustment set value for a movie film source to the image quality processor 13 (S12). If the video information supplied to the video processor 12 is not a movie film source (S11: No), the automatic image quality adjustment unit supplies an image quality adjustment set value for other than a movie film source to the image quality processor 13 (S13).

Next, the image quality adjustment controller 192 stores the image quality adjustment set value which is output in step S12 or S13 from the automatic image quality adjustment unit 190 (S14), and stops the operation of the automatic image quality adjustment unit 190 (S15). Thereafter, the image quality adjustment controller obtains a frame of the video signal which is supplied to the video processor 12, and sets the still image mode to display a still image on the video display device 14 (S16).

Next, when the user operates the operation interface 20 or the remote controller 1A to terminate the image quality adjustment on the user image quality adjustment menu 141 shown in FIG. 3, and the user image quality adjustment unit 191 is ended (S17: Yes), the image quality adjustment controller 192 outputs the stored image quality adjustment set value of the automatic image quality adjustment unit 190, and the image quality adjustment set value which is determined in the user image quality adjustment unit 191, to the image quality processor 13, and applies the values (S18). Then, the stopping of the automatic image quality adjustment unit 190 is cancelled and the portion is caused to operate (S19).

In the case where, in step S10, the still image mode indication 140 shown in FIG. 3 is displayed by the operation of the still key and the user image quality adjustment menu 141 is displayed by another operation, if, after step S16, an operation for displaying the user image quality adjustment menu 141 is performed, the user image quality adjustment menu 141 is displayed. When the above-described operations are performed, the still image mode indication 140 is displayed, and therefore the video processor 12 does not erroneously detect that, although a movie film source is used, the video source is a source other than a movie film source.

According to the first embodiment which has been described above, during the period when the user image quality adjustment unit 191 is activated, the operation of the automatic image quality adjustment unit 190 is once stopped. Therefore, the situation where the image quality adjustment is automatically performed during the period when the image quality is adjusted with using the user image quality adjustment unit 191 does not occur, and it is possible to easily know the degree of a reflection of the image quality adjustment which is set by an operation of the user.

In the case of a movie film source, when the still image mode is set, conventionally, the video processor 12 determines that the video source is not a movie film source (the video source is not a movie film source that has undergone the 2-3 pull-down process). Although the video source is a movie film source, therefore, an image quality adjustment set value for a movie film source is not applied. In the embodiment, the operation of the automatic image quality adjustment unit 190 is stopped, thereby enabling the user image quality adjustment unit 191 to operate while holding the image quality adjustment set value for a movie film source.

### Second Embodiment

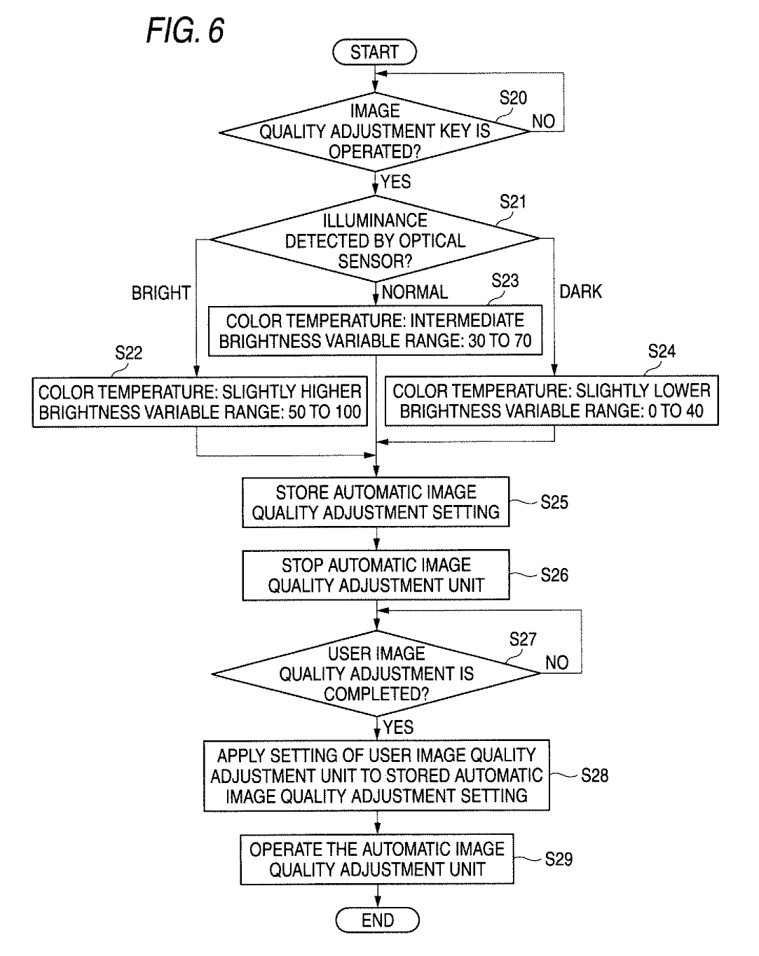

FIG. 6 is a flowchart showing an example of the operation of a display apparatus of a second embodiment of the invention. In the following description, the components which have the same configuration and function as the first embodiment are denoted by the same reference numerals.

First, when the image quality adjustment controller 192 recognizes that “IMAGE QUALITY ADJUSTMENT KEY” for activating the user image quality adjustment unit 191 is operated in the operation interface 20 or the remote controller 1A (S20: Yes), the user image quality adjustment unit 191 is activated, and the automatic image quality adjustment unit 190 is caused to operate.

The automatic image quality adjustment unit 190 inquires about the illuminance which is measured by the optical sensor 22 (S21). When the illuminance which is measured by the optical sensor 22 is larger than a threshold (S21: Bright), the portion outputs instructions for raising the color temperature to a slightly higher level, and setting a variable range of the brightness which is settable in the user image quality adjustment unit 191, to a range of, for example, 50 to 100 in the case where the maximum of the brightness is 100 and the minimum is 0, to the image quality processor 13 (S22).

When the illuminance which is measured by the optical sensor 22 is within a threshold range (S21: Normal), the automatic image quality adjustment unit outputs instructions for setting the color temperature to an intermediate value, and the variable range of the brightness which is set-table in the user image quality adjustment unit 191, to a range of 30 to 70, to the image quality processor 13 (S23). When the illuminance which is measured by the optical sensor 22 is smaller than a threshold (S21: Dark), the automatic image quality adjustment unit outputs instructions for lowering the color temperature to a slightly lower level, and setting the variable range of the brightness which is settable in the user image quality adjustment unit 191, to a range of 0 to 40, to the image quality processor 13 (S24). The above-mentioned set values of the brightness are example values.

Next, the image quality adjustment controller 192 stores the image quality adjustment set value which is output in one of steps S22 to S24 from the automatic image quality adjustment unit 190 (S25), and stops the operation of the automatic image quality adjustment unit 190 (S26).

Next, when the user operates the operation interface 20 or the remote controller 1A to terminate the image quality adjustment, and the user image quality adjustment unit 191 is ended (S27: Yes), the image quality adjustment controller 192 outputs the stored image quality adjustment set value of the automatic image quality adjustment unit 190, and the image quality adjustment set value which is determined in the user image quality adjustment unit 191, to the image quality processor 13, and applies the values (S28) Then, the stopping of the automatic image quality adjustment unit 190 is cancelled and the portion is caused to operate (S29).

According to the second embodiment which has been described above, in the same manner as the first embodiment, during the period when the user image quality adjustment unit 191 is activated, the operation of the automatic image quality adjustment unit 190 is once stopped. Therefore, the situation where the image quality adjustment is automatically performed during the period when the image quality is adjusted with using the user image quality adjustment unit 191 does not occur, and it is possible to easily know the degree of a reflection of the image quality adjustment which is set by an operation of the user.

Unlike the first embodiment, during the period when the user image quality adjustment unit 191 is activated, although a moving image is displayed on the video display device 14 in stead of a still image, it is possible to easily know the degree of a reflection of an operation performed by the user, because the operation of the automatic image quality adjustment unit 190 is stopped.

The operation of the automatic image quality adjustment unit 190 based on the supplied video signal in the first embodiment, and that of the automatic image quality adjustment unit 190 based on the detection value of the optical sensor 22 in the second embodiment may be simultaneously performed. The operation of the automatic image quality adjustment unit 190 in the first embodiment may be performed not only in the case of the still image mode, but also in the case where a moving image is displayed on the video display device 14, similarly in the second embodiment.

Alternatively, the optical sensor 22 may be disposed in the outside, and the display apparatus 1 may be configured so as to receive the detection value measured by the sensor. The sensor is not restricted to the optical sensor 22. Another physical value of the external environment such as the color temperature, the audio volume level, the temperature, the humidity, or the altitude may be measured, and the automatic image quality adjustment unit 190 may operate based on the measured value.

Alternatively, the adjustment is not restricted to the image quality adjustment. An automatic audio adjustment unit which automatically determines an audio adjustment set value of an audio adjustment that is performed in the audio processor 15, and a user audio adjustment unit may be disposed. During the adjustment in the user audio adjustment unit, similarly, a set value of the automatic audio adjustment unit may be stored, the operation of the portion may be stopped, and, after the adjustment of the user audio adjustment unit, the set values of the both portions may be applied to the audio processor 15.

What is claimed is:

1. A video processing apparatus comprising:
a user interface configured to allow a user to input operations;
a video processor configured to generate a video signal;
an automatic image quality adjustment unit configured to determine a first image quality adjustment set value based on the video signal;
a user image quality adjustment unit configured to determine a second image quality adjustment set value based on an operation input through the user interface;
an image quality processor that performs an image quality adjustment on the video signal based on the first and second image quality adjustment set values; and
a controller configured to:
store the first image quality adjustment set value that is set before the user image quality adjustment unit starts to operate and control the image quality processor to perform the image quality adjustment based on the second image quality adjustment set value when the user image quality adjustment unit determines the second image quality adjustment set value; and
control, after the image quality processor completes the image quality adjustment based on the second image quality adjustment set value, the image quality processor to perform the image quality adjustment based on the first image quality adjustment set value that is stored and the second image quality adjustment set value that is determined by the user image quality adjustment unit.

2. The apparatus according to claim 1, wherein the controller controls the video processor to convert the video signal into a still image after halting the automatic image quality adjustment unit.

3. The apparatus according to claim 1, wherein the automatic image quality adjustment unit determines the first image quality adjustment set value based on an interframe difference of the video signal.

4. The apparatus according to claim 1 further comprising a display device that displays video image based on the video signal output from the image quality processor.

5. A video processing apparatus comprising:
a sensor configured to detect an external environment and outputs a detection value that indicates the detected external environment;
a user interface configured to allow a user to input operations;
a video processor configured to generate a video signal;
an automatic image quality adjustment unit configured to determine a first image quality adjustment set value based on the video signal and the detection value;
a user image quality adjustment unit configured to determine a second image quality adjustment set value based on an operation input through the user interface;
an image quality processor configured to perform an image quality adjustment on the video signal based on the first and second image quality adjustment set values; and
a controller configured to:
store the first image quality adjustment set value that is set before the user image quality adjustment unit starts to operate and control the image quality processor to perform the image quality adjustment based on the second image quality adjustment set value when the user image quality adjustment unit determines the second image quality adjustment set value; and
control, after the image quality processor completes the image quality adjustment based on the second image quality adjustment set value, the image quality processor to perform the image quality adjustment based on the first image quality adjustment set value that is stored and the second image quality adjustment set value that is determined by the user image quality adjustment unit.

6. The apparatus according to claim 5, wherein the sensor detects an illuminance of the external environment.

7. The apparatus according to claim 5, wherein the controller controls the video processor to convert the video signal into a still image after halting the automatic image quality adjustment unit.

8. The apparatus according to claim 5, wherein the automatic image quality adjustment unit determines the first image quality adjustment set value based on an interframe difference of the video signal.

9. The apparatus according to claim 5 further comprising a display device that displays video image based on the video signal output from the image quality processor.

10. A method for processing a video signal, the method comprising:
detecting an external environment to obtain a detection value that indicates the detected external environment;
performing an automatic image quality adjustment to determine a first image quality adjustment set value based on a video signal and the detection value;
determining a second image quality adjustment set value based on an operation input by a user;
storing the first image quality adjustment set value and performing the image quality adjustment based on the second image quality adjustment set value when the second image quality adjustment set value is determined; and
performing an image quality adjustment on the video signal based on the first image quality adjustment set value and the second image quality adjustment set value.
